(19) United States
(12) Patent Application Publication
(10) Pub. No.: US 2014/0336027 A1
(43) Pub. Date: Nov. 13, 2014

(54) SYSTEM AND METHOD FOR CREATING CUSTOMIZED BOXES

(71) Applicant: Xerox Corporation, Norwalk, CT (US)

(72) Inventors: Rakesh S. Kulkarni, Webster, NY (US); Thomas L. Maloney, Webster, NY (US)

(21) Appl. No.: 13/892,865

(22) Filed: May 13, 2013

(51) Int. Cl. G06F 17/50; B31B 1/00

(52) U.S. Cl. CPC G06F 17/5086; B31B 1/00
USPC 493/55; 493/52

(57) ABSTRACT

A computer-based system for creating customized storage boxes, including: a computer with a memory element storing computer readable instructions and a processor to execute the instructions to: receive first data specifying an item for storage; receive second data specifying a number of the item for storage in at least one box or a use of the item; receive third data describing a physical attribute of the item; calculate, using the first, second, and third data, a volume of the at least one box; and transmit fourth data, including the volume. The system includes a packaging device to receive the fourth data and generate, using the fourth data, a two-dimensional layout, on a piece of media, for the at least one box. The layout includes a plurality of lines, on the piece of media for creasing or cutting the piece of media to form the at least one box.

### TECHNICAL FIELD

The present disclosure relates to a system and method for automatically creating customized boxes, in particular, creating customized boxes in response to parameters input by a user. The present disclosure also relates to a system and method for automatically creating customized boxes for storing medications, in particular, boxes sized and shaped and provided with indicia according to specific user preferences

### BACKGROUND

Commonly owned U.S. patent application Ser. Nos. 13/564,415; 13/591,285; 13/442,268; 13/439,369; and 13/331,501 disclose means for customizing documents and cutting a sheet of material into a configuration. The preceding references disclose automated control of the actual cutting and forming operations by a machine; however, data regarding the desired dimensions and configuration must be input by the user.

Commonly owned U.S. Pat. No. 8,419,601 discloses printing documents, such as shipping or packaging labels, with personalized dimensions. The dimensions can be determined based on dimensions (not determined as part of the disclosed method or system) of a three-dimensional package to which the printed document is to be attached. Commonly owned U.S. Pat. No. 7,983,792 discloses generating a printed three-dimensional object, by printing on a substrate, generating die lines, and finishing the substrate along the die lines to yield the three-dimensional object

Many individuals are required to take multiple medications at different intervals during the day or week. These individuals can keep a record of this information and take medications from their original prescription containers, or they can use ‘pill organizers’ to place all medications required for a given timeframe in specific compartments. These organizers are generic and do not aid in placing the right pills in right compartment. In addition, compartments are not sized for the specific medications to be placed in each compartment. This is an error prone as well as time consuming process. Further, the organizers are not configured to meet specific requirements of desires of a user and do not include indicia helping to identify the medication and provide other information such as instructions for taking the medication.

### SUMMARY

According to aspects illustrated herein, there is provided a computer-based method for creating customized boxes, including: storing, in at least one memory element of at least one computer, computer readable instructions; and executing, using at least one processor for the at least one computer, the computer readable instructions to: receive first data specifying at least one item for storage; receive second data specifying a first number of the at least one item for storage in at least one box or at least one use of the at least one item; receive third data describing at least one physical attribute of the at least one item; calculate, using the first, second, and third data, at least one volume of the at least one box; transmit, to a packaging device, fourth data, including the volume of the at least one box; and generate, using the fourth data and the packaging device, at least one two-dimensional layout, on at least one piece of media, for the at least one box. The layout includes a plurality of lines, on the at least one piece of media for creasing or cutting the at least one piece of media to form the at least one box.

According to aspects illustrated herein, there is provided a computer-based method for creating customized boxes for storing medication, including: storing, in at least one memory element of at least one computer, computer readable instructions; and executing, using at least one processor for the at least one computer, the computer readable instructions to: receive first data regarding at least one medication for a patient, the first data including at least one dosage of the at least one medication and at least one instruction for taking the at least one medication; receive second data including at least one size, shape, or volume of at least one pill for the at least one dosage; calculate, using the first and second data, at least one volume of at least one box for storing the at least one medication; transmit, to a packaging device, third data, including the at least one volume; generate, using the third data and the packaging device, at least one first two-dimensional layout, on at least one first piece of media, for the at least one box; and apply, to the at least one first piece of media, first indicia including the instructions. The at least one first two-dimensional layout includes a first plurality of lines for creasing or cutting the at least one first piece of media to form the at least one box.

According to aspects illustrated herein, there is provided a computer-based method for providing items in customized boxes, including: storing, in at least one first memory element of at least one first computer under control of a first business entity, first computer readable instructions; executing, using at least one first processor for the at least one first computer, the first computer readable instructions to: receive, from a third business entity, first data specifying at least one item; receive, from the third business entity, second data specifying a first number of the at least one item for storage in at least one box or at least one use of the at least one item; receive third data describing at least one physical attribute of the at least one item; calculate, using the first, second, and third data, a volume of the at least one box; receive, from the third entity, customer information regarding a recipient of the at least one item; and transmit fourth data, including the customer information and the volume of the at least one box. The method includes receiving, using a packaging device under control of a second business entity, the fourth data; generating, using the fourth data and the packaging device, at least one two-dimensional layout, on at least one piece of media, for the at least one box; receiving, by the second business entity, the at least one item from the third business entity or a fourth entity; packaging the at least one item in the at least one box formed from the at least one piece of media; and arranging transport of the at least one item, in the at least one box, to the recipient.

According to aspects illustrated herein, there is provided a computer-based system for creating customized storage boxes, including: at least one computer including at least one memory element configured to store computer readable instructions; and at least one processor for the at least one computer configured to execute the computer readable instructions to: receive first data specifying at least one item for storage; receive second data specifying a first number of the at least one item for storage in at least one box or at least one use of the at least one item; receive third data describing at least one physical attribute of the at least one item; calculate, using the first, second, and third data, at least one volume of the at least one box; and transmit fourth data, including the volume of the at least one box. The system includes a packaging device arranged to receive the fourth data and generate, using the fourth data, at least one two-dimensional layout, on at least one piece of media, for the at least one box. The layout includes a plurality of lines, on the at least one piece of media for creasing or cutting the at least one piece of media to form the at least one box.

According to aspects illustrated herein, there is provided a computer-based system for creating customized storage boxes for storing medication, including: at least one computer including at least one memory element configured to store computer readable instructions; and at least one processor for the at least one computer configured to execute the computer readable instructions to: receive first data regarding at least one medication for a patient, the first data including at least one dosage of the at least one medication and at least one instruction for taking the at least one medication; receive second data including at least one size, shape, or volume of at least one pill for the at least one dosage; calculate, using the first and second data, at least one volume of at least one box for storing the at least one medication; and transmit third data including the at least one volume. The system includes a packaging device arranged to receive the third data; generate, using the third data, at least one first two-dimensional layout, on at least one first piece of media, for the at least one box; and apply, to the at least one first piece of media, first indicia including the instructions. The at least one first two-dimensional layout includes a first plurality of lines for creasing or cutting the at least one first piece of media to form the at least one box.

According to aspects illustrated herein, there is provided a computer-based system for creating customized storage boxes, including: a packaging device; at least one first computer under control of a first business entity and including at least one first memory element configured to store first computer readable instructions; at least one first processor for the at least one first computer; and a second computer under control of a second business entity. The at least one first processor is configured to execute the first computer readable instructions to: receive, from a third business entity, first data specifying at least one item; receive, from the third business entity, second data specifying a first number of the at least one item for storage in at least one box or at least one respective use for the at least one item; receive third data describing at least one physical attribute of the at least one item; calculate, using the first, second, and third data, a volume of the at least one box; receive, from the third entity, customer information regarding a recipient of the at least one item; and transmit fourth data including the customer information and the volume of the at least one box. The packaging device is arranged to receive the fourth data and generate, using the fourth data, at least one two-dimensional layout, on at least one piece of media, for the at least one box. The second computer is arrange transport of the at least one item in at least one box to the recipient. The at least one item is received by the second business entity from the third business entity or a fourth entity, and the at least one box is formed from the at least one piece of media.

### BRIEF DESCRIPTION OF THE DRAWINGS

Various embodiments are disclosed, by way of example only, with reference to the accompanying schematic drawing in which corresponding reference symbols indicate corresponding parts, in which:

FIG. 1 is a schematic block diagram of a computer-based system for creating customized storage boxes;

FIG. 2 is a pictorial representation of a plurality of customized boxes;

FIG. 3 is a perspective view of a two-dimensional layout on a piece of media;

FIG. 4 is a pictorial representation of customized boxes for storing medications; and,

FIG. 5 is a schematic block diagram of a computer-based system for providing items in customized boxes.

### DETAILED DESCRIPTION

Moreover, although any methods, devices or materials similar or equivalent to those described herein can be used in the practice or testing of these embodiments, some embodiments of methods, devices, and materials are now described.

The following non-limiting definitions are applicable to the present invention:

It should be understood that the use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B.

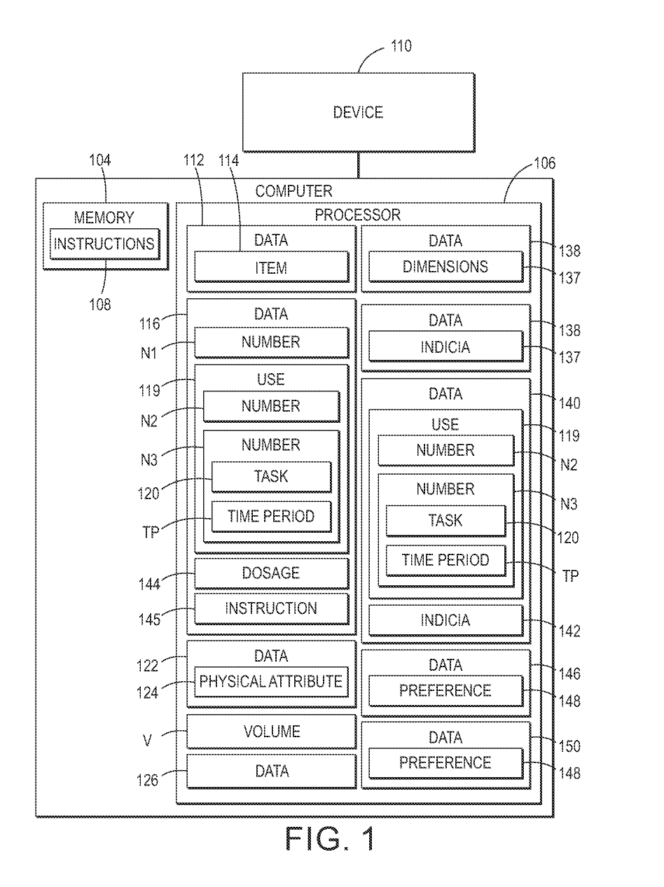

FIG. 1 is a schematic block diagram of computer-based system 100 for creating customized storage boxes.

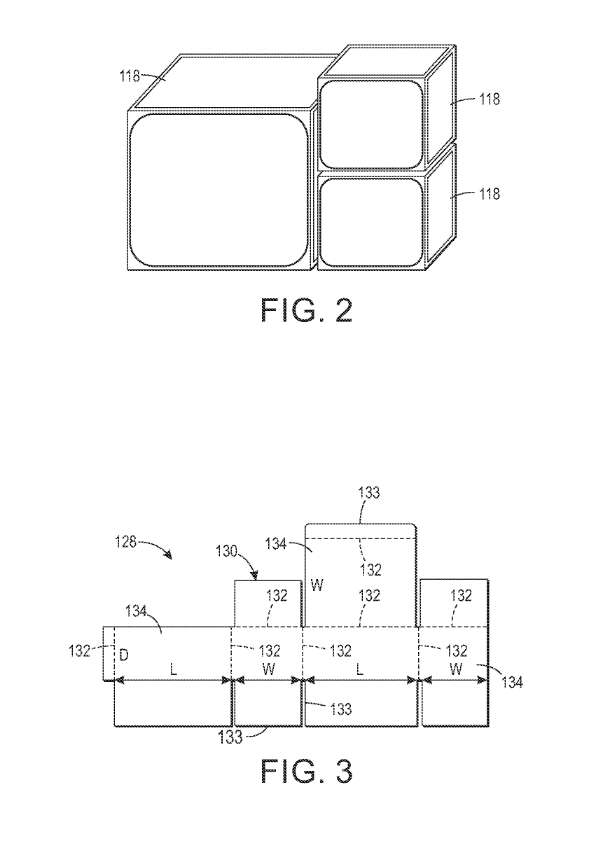

FIG. 2 is a pictorial representation of a plurality of customized boxes. The following should be viewed in light of FIGS. 1 and 2. System 100 includes at least one computer 102 including at least one memory element 104 and at least one processor 106. Element 104 is configured to store computer readable instructions 108. Hereinafter it should be understood that for any element prefaced by “at least one,” after the introduction of that element, for the sake of simplicity, the element is referred to in the singular. The system includes packaging device 110. Processor 106 is configured to execute the computer readable instructions to: receive data 112 specifying at least one item 114 for storage; and receive data 116 specifying N1 number of items 114 for storage in at least one box 118; or use 119 of item 114. In an example embodiment, use 119 includes N2 number of items 114 for storage in box 118 per at least one time period TP, or number N3 of item 114 for storage in box 118 per at least one task 120. Hereinafter it should be understood that operations attributed to processor 106 are a result of executing instructions 108. Processor 106 is configured to receive data 122 describing at least one physical attribute 124 of item 114. In an example embodiment, attribute 124 includes a size, shape, weight, or volume of item 114. Processor 106 is arranged to calculate at least one volume V of box 118 using data 112, 116, and 122.

FIG. 3 is a perspective view of a two-dimensional layout on a piece of media. The following should be viewed in light of FIGS. 1 through 3. Processor 106 is configured to transmit data 126 including volume V. The packaging device is arranged to receive data 126 and generate, using data 126, at least one two-dimensional layout 128, on at least one piece of media 130, for box 118. The layout includes a plurality of lines 132, on media 130 for creasing or cutting the piece of media to form box 118. In FIG. 2, edges 133 can be cuts made along lines 132 or an edge of media 130 itself. The layout can be on one only single piece of media 130, or can be on a plurality of pieces of media 130. Further detail regarding device 110 is provided in the following commonly owned U.S. patent application Ser. Nos. 13/564,415; 13/591,285; 13/442,268; 13/439,369; and 13/331,501, each of which applications are incorporated in their entirety herein. Media 130 can be any media known in the art, such as cardboard or plastic.

Each box 118 includes a plurality of sides 134 enclosing a space, which forms volume V. At least one side 134 is a flap or lid displaceable to close off the space or enable access to the space. In an example embodiment, there is a plurality of boxes 118 with respective volumes V. In an example embodiment, for at least two of boxes 118 in a plurality of boxes 118, the respective volumes are different. In an example embodiment, processor 106 is configured to calculate, using data 112, 116, and 122, dimensions 137 for box 118, such as length L and width W for sides 134, and transmit data 138, including the dimensions to the packaging device. The packaging device is arranged to receive data 138 and position lines 132 according to the dimensions in data 138.

In an example embodiment, processor 106 is configured to calculate N1 using use 119. In general, processor 106 must know how many items 114 are to be stored in a particular box 118. N1 could provide this information directly. However, as further described below, processor 106 also has the capability of determining N1, or more specifically, how many items 114 are to be stored in a particular box 118, by evaluating N2 and N3.

In an example embodiment, processor 106 is configured to transmit data 140 including use 119 and the packaging device is arranged to receive data 140 and apply indicia 142, included in data 140 to media 130.

In an example embodiment: data 112 specifies a plurality of items 114; data 116 specifies a respective N1 for each item in the plurality of items 114, or a respective use for each item in the plurality of items 114; and data 122 describing a respective physical attribute of each item in the plurality of items 114. Processor 106 is configured to calculate, using respective data 112, 116, and 122, respective volume V of each box 114 in the plurality of boxes 114, and transmit data 126 including respective volumes V. The packaging device is arranged to receive data 126 and generate, using data 126: two-dimensional layout 128 on one only single piece of media 130 for the entirety of the plurality of boxes; or a plurality of two-dimensional layouts 128 on a plurality of pieces of media 130 for the plurality of boxes.

In an example embodiment, respective volumes V for at least two boxes 118 in a plurality of boxes 118 are different. In an example embodiment, respective indicia 142 for at least two boxes 118 in a plurality of boxes 118 are different.

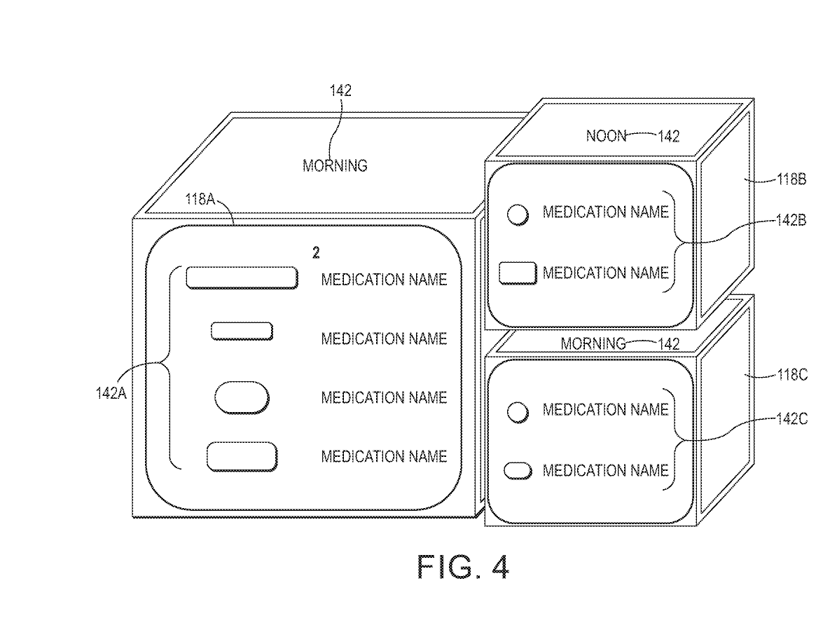

FIG. 4 is a pictorial representation of customized boxes for storing medications. The following should be viewed in light of FIGS. 1 through 4. In an example embodiment, item 114 is at least one medication for a patient, for example a prescription medication. For example, data 112 specifies the medication and data 116 specifies at least one dosage 144 of the medication and at least one instruction 145 for taking the medication. For example, data 112 and 116 are a prescription for the medication. Data 122 includes a size, shape, or volume of a pill containing dosage 144. Processor 106 is configured to calculate volume V as described above. For example, the processor is configured to determine how many pills are to be stored in each box 114 and the volume/size of each pill to calculate respective volumes V.

In an example embodiment, processor 106 is configured to receive data 146 including at least one preference 148 of the patient, different from instruction 145. That is, preferences are specific to the patient and are different from “standard” or generic instructions regarding the medication. In an example embodiment, preference 148 includes, but is not limited to: a number of boxes per day, per time of day, per day of the week, or other time period, desired by the patient; desired size or sizes for the boxes; a level of detail desired for the instructions; special instructions specific to the patient and/or the medication; and instructions regarding indicia, such as location of indicia, size, shape, and type of print, inclusion of graphics, and adding texture to a surface or surfaces of the box, such as Braille.

In an example embodiment, the processor uses preference 148 to calculate V. For example, a volume of 2 square inches for a box may be sufficient to hold the applicable medications; however, preference 148 includes a directive that no volume of a box is to be less than 4 square inches, for example, because the patient has problems opening smaller boxes. Thus, a patient preference can cause modifications to volume V. Processor 106 is configured to transmit data 150 including preference 148 to the packaging device. The packaging device is arranged to receive data 150 and use data 150 in generating layout 128, which can be different from a layout 128 generated without use of data 150. That is, a patient preference can cause modifications to the layout, for example, to accommodate the requirement for a minimum volume V. The packaging device is arranged to apply indicia 142 according to data 150. For example, the size, type, or location of indicia can be as required by preference 148.

For example, as shown in FIG. 4, an integral formation of three boxes 118A, 118B, and 118C is formed to hold medications for a patient for one day (morning, noon, and evening). The respective sizes/shapes/volumes of each box are different. The difference can be a result of the number and size of the medications being stored as well as a result of preferences 148. Indicia 142A, 142B, and 144C, can be derived from a combination of dosage 144, instructions 145, and preferences 148.

As described above for a plurality of items 114, the operations described above for at least one medication can be applied to a plurality of medications. Preferences 148 can be specific to each medication or groupings of medications.

Customized boxes 118 for medications enable better adherence to medication regimens with the attendant advantages, such as reducing side-effects, attaining full benefits of the regimen, and avoiding further medical complications or problems. The better adherence is clearly of great medical benefit to the patient, but also can reduce costs for the patient and the medical system providing care for the patient or paying for the patient's care.

Thus, apparatus 100 enables a flexible, automated means for producing customized boxes of any size, shape or configuration in response to data input by a user, or received by computer 102 from another computerized system. The data input by the user or received by the computer does not directly specify the size, shape or configuration of the boxes. Instead, information that is readily available to an entity supplying item 114, such as data 112, 116 and 122, is used by processor 106 to automatically generate volume and dimension information (data 126 and 138). That is, it is not necessary for a person to calculate or otherwise determine dimensions and configurations. Further, adjustments and modifications are made automatically. If any of data 112, 116 or 122 change, processor 106 makes the required adjustments, again, without operator intervention.

Within the customized framework described above, even further customization is enabled through application of personalized data such as data 146 and 150. For example, if customized boxes are being fabricated for a particular weekly dosages of one or more medications, one particular set of volumes and dimensions may be adequate to store the medications and may be used for a large number of patients. However, this set of volumes and dimensions can be further customized according to data 146 and 150, such that the boxes for a particular patient can be further customized as described above, for example, changing size or indicia. Of course, each particular set of boxes 118 for a particular patient can fabricated at the onset using data 112, 116, 122, 146, and 150.

Particular detail has been provided for a medical application of system 100; however, it should be understood that system 100 is applicable to a very broad range of applications. In essence, system 100 can be used with any product that includes packaging of components. For example, many products are sold in an unassembled state. For example, children's toys or furniture are sold with component parts and various fasteners to secure the component parts into the desired finished product. Typically, the fasteners are combined in one bag with separate written instructions identifying the individual fasteners and how the individual fasteners are to be used. This system is quite prone to user error and can be confusing and frustrating for the user. With system 100 customized boxes for each type of fastener can be provided and indicia explaining the use of the fastener can be applied directly to the box. Even further, a plurality of boxes containing various fasteners can be nested or otherwise configured so that the boxes can only be accessed according the order of usage of the fasteners, required for proper assembly, contained in the boxes.

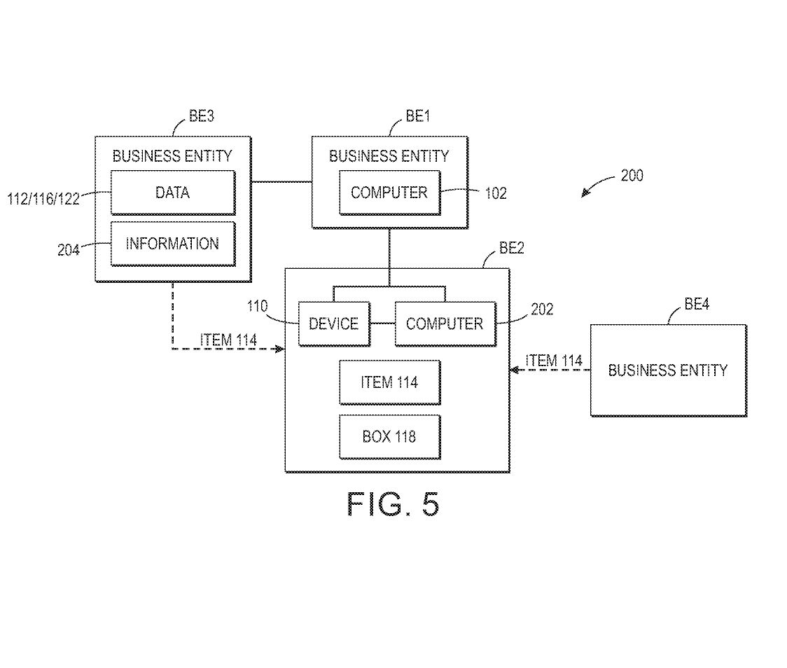

FIG. 5 is a schematic block diagram of computer-based system 200 for providing items in customized boxes. System 200 includes computer 102 under control of business entity BE1. System 200 includes packaging device 110 and computer 202 under control of business entity BE2, different from BE1. The discussion regarding computer 102 and device 110 is applicable to system 200 except as noted. Processor 106 is configured to execute computer readable instructions 108 to receive, from business entity BE3, different from BE1 and BE2: data 112; data 116; and data 122. As described above, processor 106 is configured to calculate volume V using data 112, 116, and 122. Processor 106 is configured to receive, from BE3, customer information 204 regarding a recipient of item 114, for example, a name and address of the recipient and shipping instructions. Processor 106 is configured to transmit data 126, including volume V and information 204.

Device 110 is arranged to receive data 126, directly or indirectly, for example via computer 202 and generate, using data 126, layout 128 on media 130. Computer 202 is configured to arrange transport of item 114 in box 118 to the recipient. Item 114 is received by business entity BE2 from BE3 or business entity B4, for example, a supplier for BE3. BE2 is responsible for forming box 118 from media 130 and packaging item 114 in box 118 for shipment.

In an example embodiment, business entity BE3 is a legal supplier of prescription medications or a legal prescriber of prescription medications, such as a pharmacist. That is, BE3 can be a pharmacist and a pharmacy prescribing and providing, respectively, the medication; or BE3 can be a medication distributor receiving prescriptions from a pharmacist for a patient and provided prescribed medications to the patient. Thus, system 200 provides customized and personalized medication containers in an automated large scale setting.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A computer-based method for creating customized boxes, comprising:
storing, in at least one memory element of at least one computer, computer readable instructions; and,
executing, using at least one processor for the at least one computer, the computer readable instructions to:
receive first data specifying at least one item for storage;
receive second data specifying:
a first number of the at least one item for storage in at least one box; or,
at least one use of the at least one item;
receive third data describing at least one physical attribute of the at least one item;
calculate, using the first, second, and third data, at least one volume of the at least one box;
transmit, to a packaging device, fourth data, including the volume of the at least one box; and,
generate, using the fourth data and the packaging device, at least one two-dimensional layout, on at least one piece of media, for the at least one box, wherein:
the layout includes a plurality of lines, on the at least one piece of media for creasing or cutting the at least one piece of media to form the at least one box.

2. The computer-based method of claim 1, further comprising executing, using the at least one processor, the computer readable instructions to:
calculate, using the first, second, and third data, dimensions for the at least one box;
transmit, to the packaging device, the fourth data including the dimensions; and,
positioning, using the fourth data and the packaging device, a plurality of lines according to the dimensions.

3. The computer-based method of claim 1, wherein:
the at least one box includes first and second boxes with first and second volumes, respectively; and,
the first volume is different from the second volume.

4. The computer-based method of claim 1, further comprising executing, using the at least one processor, the computer readable instructions to:
calculate the first number using the at least one use of the at least one item.

5. The computer-based method of claim 1, further comprising executing, using the at least one processor, the computer readable instructions to:
transmit fifth data, including the at least one use of the at least one item, to the packaging device, wherein:
the packaging device is arranged to apply, to the at least one piece of media, indicia included in the fifth data.

6. The computer-based method of claim 5, wherein:
the at least one box includes first and second boxes; and,
respective indicia for the first box are different from respective indicia for the second box.

7. The computer-based method of claim 1, wherein:
the third data includes a size, shape, weight, or volume of the at least one item.

8. The computer-based method of claim 1, further comprising executing, using the at least one processor for the at least one computer, the computer readable instructions to:
receive the first data specifying a plurality of items;
receive the second data specifying:
a respective first number of each item in the plurality of items for storage in a plurality of boxes; or,
a respective use for each item in the plurality of items;
receive respective third data describing at least one respective physical attribute of said each item in the plurality of items;
calculate, using the respective first, second, and third data, a respective volume of each box in the plurality of boxes;
transmit, to the packaging device, fourth data, including the respective volumes; and,
generate, using the fourth data and the packaging device:
a first two-dimensional layout on one only single piece of media for the entirety of the plurality of boxes; or,
a plurality of two-dimensional layouts on plurality of pieces of media.

9. The computer-based method of claim 1, further comprising executing, using the at least one processor for the at least one computer, the computer readable instructions to:
receive the first data specifying a medication for a patient;
receive the second data including:
a dosage of the medication; and,
instructions for taking the medication;
receive the third data including a size, shape, or volume of a pill containing the dosage;
calculate, using the respective first, second, and third data, a respective volume of each box in a plurality of boxes;
transmit, to the packaging device, fourth data, including the respective volumes;
generate, using the fourth data and the packaging device:
a first two-dimensional layout on one only single piece of media for the entirety of the plurality of boxes; or,
a plurality of two-dimensional layouts on plurality of pieces of media; and,
apply indicia included in the instructions to the single piece of media or to the plurality of pieces of media.

10. A computer-based method for creating customized boxes for storing medication, comprising:
storing, in at least one memory element of at least one computer, computer readable instructions; and,
executing, using at least one processor for the at least one computer, the computer readable instructions to:
receive first data regarding at least one medication for a patient, the first data including:
at least one dosage of the at least one medication; and,
at least one instruction for taking the at least one medication;
receive second data including at least one size, shape, or volume of at least one pill for the at least one dosage;
calculate, using the first and second data, at least one volume of at least one box for storing the at least one medication;
transmit, to a packaging device, third data, including the at least one volume;
generate, using the third data and the packaging device, at least one first two-dimensional layout, on at least one first piece of media, for the at least one box; and,
apply, to the at least one first piece of media, first indicia including the instructions, wherein:
the at least one first two-dimensional layout includes a first plurality of lines for creasing or cutting the at least one first piece of media to form the at least one box.

11. The computer-based method of claim 10, further comprising executing, using the at least one processor, the computer readable instructions to:
receive fourth data including at least one preference of the patient, different from the at least one instruction;
calculate, using the fourth data, the at least one volume;
transmit the fourth data to the packaging device; and,
generate, using the fourth data and the packaging device, at least one second two-dimensional layout, different from the at least one first two-dimensional layout, on the at least one second piece of media, wherein:
a difference between the first and second layouts is to meet requirements of the fourth data.

12. The computer-based method of claim 11, wherein the at least one preference is selected from the group consisting of a number of the at least one box per time period, a size of the at least box, a level of detail of the instructions, special instructions, a size or shape of indicia, and texture on a surface of the at least one box.

13. The computer-based method of claim 10, further comprising executing, using the at least one processor, the computer readable instructions to:
receive fourth data including at least one preference of the patient, different from the at least one instruction;
transmit the fourth data to the packaging device; and,
apply, using the fourth data and the packaging device, second indicia, included in the fourth data, to the at least one piece of media.

14. The computer-based method of claim 13, wherein the at least one preference is selected from the group consisting of a number of the at least one box per time period, a size of the at least box, a level of detail of the instructions, special instructions, a size or shape of indicia, and texture on a surface of the at least one box.

15. The computer-based method of claim 10, further comprising executing, using the at least one processor, the computer readable instructions to:
receive the first data regarding a plurality of medications for the patient, the first data including:
respective dosages of each medication in the plurality of medications; and,
respective instructions for taking said each medication in the plurality of medications;
receive the second data including a respective size, shape, or volume of a respective pill for said each medication in the plurality of medications;
calculate, using the first and second data, a respective volume of each box in a plurality of boxes;
transmit, to the packaging device, the third data, including the respective volumes;
generate, using the third data and the packaging device, the at least one two-dimensional layout for the plurality of boxes; and,
apply respective indicia included in the respective instructions to the at least one piece of media.

16. A computer-based method for providing items in customized boxes, comprising:
storing, in at least one first memory element of at least one first computer under control of a first business entity, first computer readable instructions;
executing, using at least one first processor for the at least one first computer, the first computer readable instructions to:
receive, from a third business entity, first data specifying at least one item;
receive, from the third business entity, second data specifying:
a first number of the at least one item for storage in at least one box; or,
at least one use of the at least one item;
receive third data describing at least one physical attribute of the at least one item;
calculate, using the first, second, and third data, a volume of the at least one box;
receive, from the third entity, customer information regarding a recipient of the at least one item; and,
transmit fourth data, including the customer information and the volume of the at least one box;
receiving, using a packaging device under control of a second business entity, the fourth data;
generating, using the fourth data and the packaging device, at least one two-dimensional layout, on at least one piece of media, for the at least one box;
receiving, by the second business entity, the at least one item from the third business entity or a fourth entity;
packaging the at least one item in the at least one box formed from the at least one piece of media; and,
arranging transport of the at least one item, in the at least one box, to the recipient.

17. The computer-based method of claim 16, further comprising executing, using the first at least one processor, the first computer readable instructions to:
calculate the first number using the at least one use of the at least one item.

18. The computer-based method of claim 16, further comprising:
executing, using the first at least one processor, the first computer readable instructions to transmit fifth data, including the at least one use of the at least one item, to the at least one second processor; and,
executing, using the second at least one processor, the second computer readable instructions to apply, to the at least one piece of media, indicia included in the fifth data.

19. The computer-based method of claim 16, wherein:
the third business entity is a legal supplier of prescription medications or a legal prescriber of prescription medications, the method further comprising:
executing, using the at least one first processor, the first computer readable instructions to:
receive, from the third business entity, the first data specifying at least one prescription medication;
receive, from the third business entity, the second data specifying:
at least one dosage of the at least one medication; and,
at least one instruction for taking the at least one medication; and,
receive the third data including at least one size, shape, or volume for at least one pill containing the at least one dosage.

20. A computer-based system for creating customized storage boxes, comprising:
at least one computer including at least one memory element configured to store computer readable instructions;
at least one processor for the at least one computer configured to execute the computer readable instructions to:
receive first data specifying at least one item for storage;
receive second data specifying:
a first number of the at least one item for storage in at least one box; or,
at least one use of the at least one item;
receive third data describing at least one physical attribute of the at least one item;
calculate, using the first, second, and third data, at least one volume of the at least one box; and,
transmit fourth data, including the volume of the at least one box; and,
a packaging device:
arranged to receive the fourth data; and,
generate, using the fourth data, at least one two-dimensional layout, on at least one piece of media, for the at least one box, wherein:
the layout includes a plurality of lines, on the at least one piece of media for creasing or cutting the at least one piece of media to form the at least one box.

21. The computer-based system of claim 20, wherein:
the at least one processor is configured to execute the computer readable instructions to:
calculate, using the first, second, and third data, dimensions for the at least one box; and,
transmit, to the packaging device, the fourth data including the dimensions; and,
the packaging device is arranged to:
receive the fourth data; and,
position, using the fourth data, the plurality of lines according to the dimensions.

22. The computer-based system of claim 20, wherein the at least one processor is configured to execute the computer readable instructions to:
calculate the first number using the at least one use of the at least one item.

23. The computer-based system of claim 20, wherein:
the at least one processor is configured to execute the computer readable instructions to transmit the fifth data, including the at least one use of the at least one item; and,
the packaging device is arranged to:
receive the fifth data; and,
apply, to the at least one piece of media, indicia included in the fifth data.

24. The computer-based system of claim 23, wherein:
the at least one box includes first and second boxes; and,
respective indicia for the first box are different from respective indicia for the second box.

25. The computer-based system of claim 20, wherein:
the third data includes a size, shape, weight, or volume of the at least one item.

26. The computer-based system of claim 20, wherein:
the at least one processor is configured to execute the computer readable instructions to:
receive the first data specifying a plurality of items;
receive the second data specifying:
a respective first number of each item in the plurality of items for storage in a plurality of box; or,
a respective use of each item in the plurality of items
receive respective third data describing at least one respective physical attribute of said each item in the plurality of items;
calculate, using the respective first, second, and third data, a respective volume of each box in the plurality of boxes; and,
transmit, to the packaging device, fourth data, including the respective volumes; and,
the packaging device is arranged to:
receive the fourth data; and,
generate, using the fourth data:
a first two-dimensional layout on one only single piece of media for the entirety of the plurality of boxes; or,
a plurality of two-dimensional layouts on plurality of pieces of media.

27. The computer-based system of claim 20, wherein:
the at least one processor is configured to execute the computer readable instructions to:
receive the first data specifying a medication for a patient;
receive the second data including:
a dosage of the medication; and,
instructions for taking the medication;
receive the third data including a size, shape, or volume of a pill containing the dosage;
calculate, using the respective first, second, and third data, a respective volume of each box in a plurality of boxes; and,
transmit fourth data including the respective volumes; and,
the packaging device is arranged to:
receive the fourth data;
generate, using the fourth data:
a first two-dimensional layout on one only single piece of media for the entirety of the plurality of boxes; or,
a plurality of two-dimensional layouts on plurality of pieces of media; and,
apply indicia included in the instructions to the single piece of media or to the plurality of pieces of media.

28. A computer-based system for creating customized storage boxes for storing medication, comprising:
at least one computer including at least one memory element configured to store computer readable instructions;
at least one processor for the at least one computer configured to execute the computer readable instructions to:
receive first data regarding at least one medication for a patient, the first data including:
at least one dosage of the at least one medication; and,
at least one instruction for taking the at least one medication;
receive second data including at least one size, shape, or volume of at least one pill for the at least one dosage;
calculate, using the first and second data, at least one volume of at least one box for storing the at least one medication; and,
transmit third data including the at least one volume; and,
a packaging device arranged to receive the third data;
generate, using the third data, at least one first two-dimensional layout, on at least one first piece of media, for the at least one box; and,
apply, to the at least one first piece of media, first indicia including the instructions, wherein:
the at least one first two-dimensional layout includes a first plurality of lines for creasing or cutting the at least one first piece of media to form the at least one box.

29. The computer-based system of claim 28, wherein:
the at least one processor is configured to execute the computer readable instructions to:
receive fourth data including at least one preference of the patient, different from the at least one instruction;
calculate, using the fourth data, the at least one volume; and,
transmit the fourth data; and,
the packaging device is arranged to:
receive the fourth data; and,
generate, using the fourth data, at least one second two-dimensional layout, different from the at least one first two-dimensional layout, on the at least one second piece of media, wherein:
a difference between the first and second layouts is to meet requirements of the fourth data.

30. The computer-based system of claim 28, wherein the at least one preference is selected from the group consisting of a number of the at least one box per time period, a size of the at least box, a level of detail of the instructions, special instructions, a size or shape of indicia, and texture on a surface of the at least one box.

31. The computer-based system of claim 28, wherein:
the at least one processor is configured to execute the computer readable instructions to:
receive fourth data including at least one preference of the patient, different from the at least one instruction; and,
transmit the fourth data; and,
the packaging device is arranged to:
receive the fourth data; and,
apply, using the fourth data, second indicia, included in the fourth data, to the at least one piece of media.

32. The computer-based system of claim 31, wherein the at least one preference is selected from the group consisting of a number of the at least one box per time period, a size of the at least box, a level of detail of the instructions, special instructions, a size or shape of indicia, and texture on a surface of the at least one box.

33. The computer-based system of claim 28, wherein:
the at least one processor is configured to execute the computer readable instructions to:
receive the first data regarding a plurality of medications for the patient, the first data including:
respective dosages of each medication in the plurality of medications; and,
respective instructions for taking said each medication in the plurality of medications;
receive the second data including a respective size, shape, or volume of a respective pill for said each medication in the plurality of medications;
calculate, using the first and second data, a respective volume of each box in a plurality of boxes; and,
transmit the third data, including the respective volumes;
the packaging device is arranged to:
receive the third data;
generate, using the third data, the at least one two-dimensional layout for the plurality of boxes; and,
apply respective indicia included in the respective instructions to the at least one piece of media.

34. A computer-based system for supplying items in customized boxes, comprising:
a packaging device;
at least one first computer under control of a first business entity and including at least one first memory element configured to store first computer readable instructions;
at least one first processor for the at least one first computer; and,
a second computer under control of a second business entity, wherein:
the at least one first processor is configured to execute the first computer readable instructions to:
receive, from a third business entity, first data specifying at least one item;
receive, from the third business entity, second data specifying:
a first number of the at least one item for storage in at least one box; or,
at least one respective use for the at least one item;
receive third data describing at least one physical attribute of the at least one item;
calculate, using the first, second, and third data, a volume of the at least one box;
receive, from the third entity, customer information regarding a recipient of the at least one item; and,
transmit fourth data including the customer information and the volume of the at least one box;
the packaging device is arranged to:
receive the fourth data; and,
generate, using the fourth data, at least one two-dimensional layout, on at least one piece of media, for the at least one box;
the second computer is arrange transport of the at least one item in at least one box to the recipient; and,
the at least one item is received by the second business entity from the third business entity or a fourth entity, and the at least one box is formed from the at least one piece of media.

35. The computer-based system of claim 34, wherein the at least one first processor is configured to execute the first computer readable instructions to calculate the first number using the second or third number.

36. The computer-based system of claim 34, wherein:
the at least one first processor is configured to execute the first computer readable instructions to:
transmit fifth data including the at least one use of the at least one item; and,
the at least one second processor is configured to execute the second computer readable instructions to:
receive the fifth data; and,
apply to the at least one piece of media, using the packaging device, indicia included in the fifth data.

37. The computer-based system of claim 34, wherein:
the third business entity is a legal supplier of prescription medications or a legal prescriber of prescription medications:
the at least one first processor is configured to execute the first computer readable instructions to:
receive, from the third business entity, the first data specifying at least one prescription medication;
receive, from the third business entity, the second data specifying:
at least one dosage of the at least one medication; and,
at least one instruction for taking the at least one medication; and,
receive the third data including at least one size, shape, or volume for at least one pill containing the at least one dosage.
